(19) United States
(12) Patent Application Publication
(10) Pub. No.: US 2011/0273892 A1
(43) Pub. Date: Nov. 10, 2011

(54) SOLID STATE LIGHTING ASSEMBLY

(75) Inventors: MATTHEW EDWARD MOSTOLLER, HUMMELSTOWN, PA (US); RONALD MARTIN WEBER, ANNVILLE, PA (US)

(73) Assignee: TYCO ELECTRONICS CORPORATION, BERWYN, PA (US)

(21) Appl. No.: 12/775,874

(22) Filed: May 7, 2010

(51) Int. Cl. F21V 3/04; F21V 17/06

(52) U.S. Cl. 362/311.01; 362/433

(57) ABSTRACT

A solid state lighting system includes a solid state lighting device emitting light, and an optical device positioned adjacent the solid state lighting device, which receives the light emitted from the solid state lighting device. A clip holds the optical device relative to the solid state lighting device. The clip includes a base configured to be mounted to a substrate proximate to the solid state lighting device. The clip also includes a latch extending from the base that has a latching surface engaging the optical device to hold the optical device in position with respect to the solid state lighting device.

### BACKGROUND OF THE INVENTION

The subject matter herein relates generally to lighting fixtures, and more particularly, to optics for solid state lighting assemblies.

Solid-state light lighting systems use solid state light sources, such as light emitting diodes (LEDs), and are being used to replace other lighting systems that use other types of light sources, such as incandescent or fluorescent lamps. The solid-state light sources offer advantages over the lamps, such as rapid turn-on, rapid cycling (on-off-on) times, long useful life span, low power consumption, narrow emitted light bandwidths that eliminate the need for color filters to provide desired colors, and so on.

Solid state lighting systems sometimes include LEDs soldered down to a printed circuit board (PCB). The PCB then is mounted on a base (e.g., a heat sink) of a lighting fixture. In known solid state lighting systems, optical devices, such as lenses, cover the light sources to control the lighting characteristics of the lighting system, such as to direct the light in various patterns. The optical devices are mounted to the PCB or the base using glue, double-sided tape, or heat staking. These processes have disadvantages. For example, the glue or double sided tape is difficult to handle and apply. Additionally, locational accuracy of the optical device with respect to the LED may be difficult to achieve with glue or double sided tape. Furthermore, over time, because of the elevated temperatures associated with operating the lighting system, the glue, double sided tape and the heat stake tend to fail and the optical device loses position over the light source. Such failure requires service or replacement of the lighting fixture. Problems may also arise when the optical device, the lighting source and/or the PCB needs to be replaced. The known attachment methods of using glue, double sided tape or heat staking provide a replace ability issue, as removal of the optical device may destroy the optical device, the lighting source and/or the PCB. Additionally, replacement may be tedious and may require a skilled person to perform the removal and replacement of the optical device, the lighting source and/or the PCB.

### BRIEF DESCRIPTION OF THE INVENTION

In one embodiment, a solid state lighting system is provided that includes a solid state lighting device emitting light, and an optical device positioned adjacent the solid state lighting device, which receives the light emitted from the solid state lighting device. A clip holds the optical device relative to the solid state lighting device. The clip includes a base configured to be mounted to a substrate proximate to the solid state lighting device. The clip also includes a latch extending from the base that has a latching surface engaging the optical device to hold the optical device in position with respect to the solid state lighting device.

In another embodiment, a clip is provided for holding an optical device with respect to a solid state lighting device. The clip includes a base having a mounting surface configured to be mounted to a substrate proximate to the solid state lighting device. The clip also includes a latch extending from the base. The latch has a latching surface being configured to engage the optical device to hold a relative position of the optical device with respect to the base.

In a further embodiment, a retainer for optical devices is provided that includes a clip having a base that is surface mounted to a substrate proximate to a solid state lighting device. The clip has a receiving space removably receiving the optical devices therein. The clip has a latch configured to engage the optical devices to hold the optical devices in the receiving space. The clip is configured to selectively receive, in the receive space, different types of optical devices having different optical characteristics without removing the clip or the solid state lighting assembly.

### BRIEF DESCRIPTION OF THE DRAWINGS

FIG. 1 illustrates a solid state lighting system formed in accordance with an exemplary embodiment.

FIG. 2 is a side sectional view of the solid state lighting system shown in FIG. 1.

FIG. 3 is a bottom perspective view of a clip for the solid state lighting system.

FIG. 4 is a perspective view of an alternative clip for the solid state lighting system.

FIG. 5 is a perspective view of an alternative solid state lighting system.

FIG. 6 is a top perspective view of an alternative clip for the solid state lighting system shown in FIG. 5.

FIG. 7 is a side view of an alternative solid state lighting system.

FIG. 8 is a top view of a portion of the solid state lighting system shown in FIG. 7.

FIG. 9 is an exploded view an alternative solid state lighting system.

FIG. 10 is a side view of a portion of an alternative clip for the solid state lighting system shown in FIG. 9.

FIG. 11 is a side view of another alternative solid state lighting system.

### DETAILED DESCRIPTION OF THE INVENTION

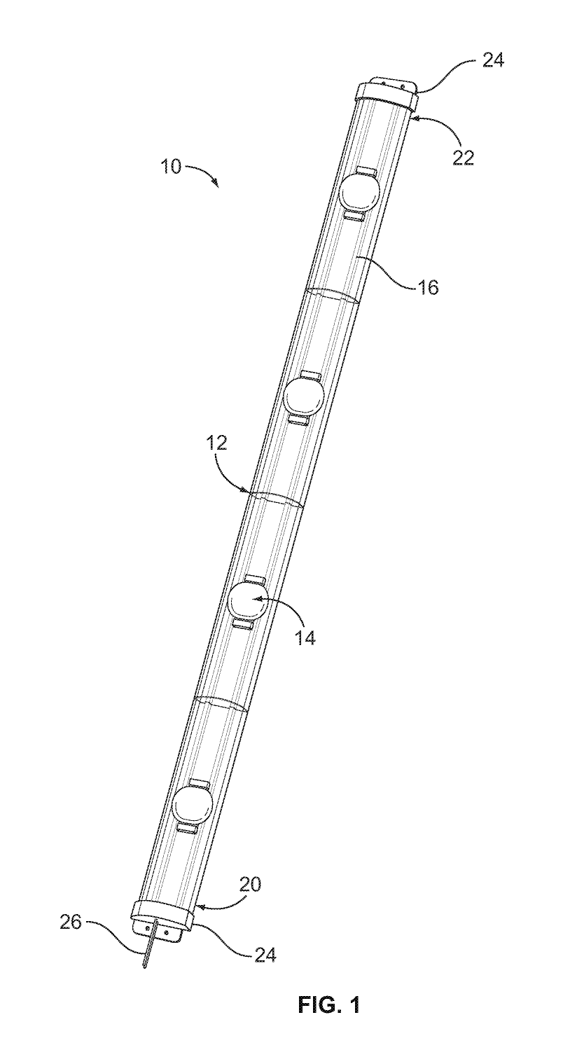

FIG. 1 is a perspective view of an exemplary embodiment of a lighting fixture 10. The lighting fixture 10 includes a base 12, one or more solid state lighting assemblies 14 that emit light, and an optional lens 16 mounted on the base 12. In an exemplary embodiment, the base 12 constitutes a heat sink. The solid state lighting assemblies 14 are mounted to the heat sink such that heat produced by the solid state lighting assemblies 14 is dissipated by the heat sink.

The base 12 extends a length from an end 20 to an opposite end 22. The lens 16 extends along the base 12 from the end 20 to the end 22 such that the lens 16 extends over each of the solid state lighting assemblies 14. In the exemplary embodiment, the lens 16 is sufficiently translucent to enable the base 12 and the solid state lighting assemblies 14 to be seen through the lens 16. End caps 24 or other suitable structures are optionally provided at the ends 20 and 22 of the base 12 to seal the interior space between the lens 16 and the base 12 of the lighting fixture 10. The end caps 24 may incorporate an electrical ballast (not shown) or other electrical device that supplies power to the lighting fixture.

The lighting fixture 10 is connected to a main power cable 26 that provides electrical power to the lighting fixture 10 from an electrical power source (not shown). In the exemplary embodiment, the main power cable 26 is fed to the end cap 24 and is electrically connected to each of the solid state lighting assemblies 14, such as via a circuit board, separate connectors and/or separate cables (not shown) that extend between and electrically connects the adjacent solid state lighting assemblies 14.

The exemplary embodiment of the lighting fixture 10 is what is commonly referred to as a “light bar” because the base 12 is elongated and the solid state lighting assemblies 14 are arranged successively along the length of the base 12. The lighting fixture 10 may be used for residential, commercial, and/or industrial lighting. The lighting fixture 10 may be used for general purpose lighting, or alternatively, may have a customized application, end use, and/or the like. One exemplary use for the lighting fixture 10 is for lighting food and/or beverage display cases, for example in grocery stores, supermarkets, convenience stores, and/or the like.

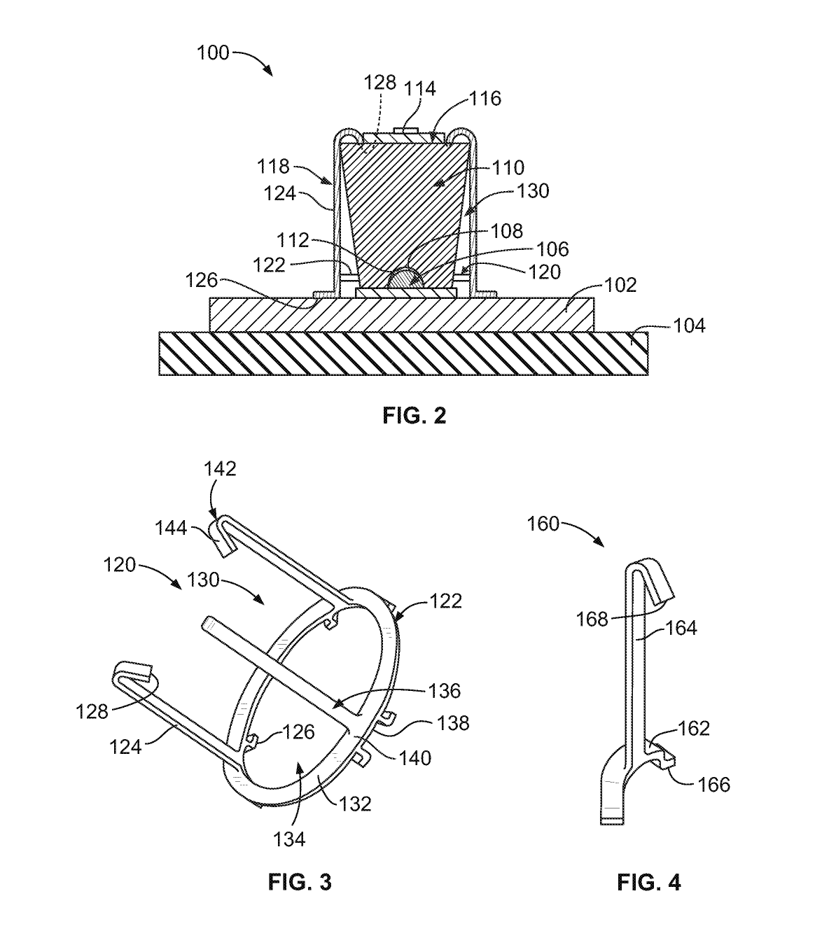

FIG. 2 is a side sectional view of a solid state lighting assembly 100. The solid state lighting assembly 100 is configured for use with the lighting fixture 10 (shown in FIG. 1) in place of the solid state lighting assembly 14. The solid state lighting assembly 100 may be used in other types of lighting fixtures other than a light bar. The solid state lighting assembly 100 includes a substrate 102. In an exemplary embodiment, the substrate 102 constitutes a circuit board. Alternatively, the substrate 102 may be a dielectric base configured to support the other components of the solid state lighting assembly 100. The substrate 102 is mounted to a heat sink 104. Optionally, the heat sink 104 may constitute the base 12 (shown in FIG. 1). In an alternative embodiment, rather than having the substrate 102 separate from the heat sink 104, the substrate 102 and heat sink 104 may constitute a single, integral component.

The solid state lighting assembly 100 includes a solid state lighting device 106. In an exemplary embodiment, the solid state lighting device 106 constitutes a light emitting diode (LED). Other types of solid state lighting devices may be used in alternative embodiments. The solid state lighting device 106 emits light through an end 108 thereof. The solid state lighting device 106 is mounted to the substrate 102. Optionally, the substrate 102 may include circuits thereon that route power to the solid state lighting device 106. Heat generated by the solid state lighting device 106 is transferred through the substrate 102 to the heat sink 104.

The solid state lighting assembly 100 includes an optical device 110. The optical device 110 is positioned with respect to the solid state lighting device 106 to receive light emitted therefrom. Optionally, the optical device may be a total internal reflecting (TIR) device, a refractive device, a reflective device, or combination thereof. In the illustrated embodiment, the optical device 110 includes a light receiving end 112 and light emitting end 114 opposite the light receiving end 112. The light emitting end 114 may emit light to the external environment. Alternatively, the light emitting end 114 may emit light into another device or object for illuminating such device or for further directing the light downstream. In an exemplary embodiment, the light receiving end 112 is positioned adjacent to the end 108 of the solid state lighting device 106. The light receiving end 112 may abut against the end 108. The optical device 110 may include a single element, or alternatively, may include multiple elements, such as multiple lenses for use with multiple solid state lighting devices 106. For example, multiple optical devices 110 could be arranged in an array of optical devices molded in one piece or secured together, and used with a multi-LED array.

The optical device 110 is used with the solid state lighting device 106 to control the optical characteristics of the light emitted from the solid state lighting device 106. For example, the optical device 110 may control a lighting pattern by directing the light from the light emitting end 114 in a particular pattern. In an exemplary embodiment, different types of optical devices 110 may be provided for controlling the optical characteristics in different ways. For example, one type of optical device 110 may be used to focus the light emitted from the solid state lighting device 106. Another type of optical device 110 may be used to spread the light emitted from the solid state lighting device 106.

In an exemplary embodiment, the optical device 110 constitutes a lens. The optical device 110 may be manufactured from a plastic material, such as a plastic resin. The optical device 110 may be an acrylic material or a polycarbonate material. The optical device 110 may control the optical characteristics by emitting the light from the light emitting end 114 in a particular pattern or direction. For example, the light may be emitted from the light emitting end 114 in a circular pattern. Alternatively, the light may be emitted from the light emitting end 114 in an elliptical pattern, or in another pattern. The light may be emitted from the light emitting end 114 in a direction perpendicular to the end 108 of the solid state lighting device 106. Alternatively, the optical device 110 may focus or direct the light in a non-perpendicular direction.

The optical device 110 includes a clip engagement feature 116. Optionally, the clip engagement feature 116 may constitute a planar surface. Alternatively, the clip engagement feature 116 may constitute a pocket. Alternatively, the clip engagement feature 116 may constitute a protrusion. In another alternative embodiment, the clip engagement feature 116 may constitute a shoulder or ledge.

The solid state lighting assembly 100 includes a retainer 118 configured to hold the optical device 110 in position with respect to the solid state lighting device 106. In an exemplary embodiment, the retainer 118 includes one or more clips 120. The clip 120 includes a base 122 and a latch 124. The base 122 has a mounting surface 126 configured to be mounted to the substrate 102 proximate to the solid state lighting device 106. Optionally, the mounting surface 126 may be planar and may be configured for surface mounting to the substrate 102. For example, the mounting surface 126 may be soldered to the substrate 102. Other types of attachment means and processes are possible in alternative embodiments other than soldering. For example, the mounting surface 126 may be attached using epoxy, glue a board lock, a fastener, or another method.

The latches 124 extend from the base 122. The latches 124 include latching surfaces 128 that engage the optical device 110. The latches 124 engage the clip engagement feature 116 of the optical device 110. When the latches 124 engage the optical device 110, the latches 124 hold the relative position of the optical device 110 with respect to the solid state lighting device 106 and with respect to the base 122. Any number of latches 124 may be used to secure the optical device 110. Optionally, three latches 124 may be utilized to help center the optical device 110 within the clip 120. Alternatively, the clip 120 may include less than three latches 124, such as two latches 124 that engage opposite sides of the optical device 110. In such embodiment, the optical device 110 may include locating features that hold a side-to-side and/or rotational position of the optical device 110 with respect to the latches 124. In other alternative embodiments, more than three latches 124 may be provided.

The clip 120 includes a receiving space 130 bounded by the latches 124 and the base 122. The receiving space 130 is positioned generally vertically above the solid state lighting device 106. During assembly, after the clip 120 is mounted to the substrate 102, the optical device 110 may be loaded into the receiving space 130. In an exemplary embodiment, the optical device 100 is loaded into the receiving space 130 from above the clip 120.

The latches 124 are deflectable such that the latches 124 are deflected outward as the optical device 110 is loaded into the receiving space 130. The latches 124 spring back into a latched position, as shown in FIG. 2, once the optical device 110 is fully loaded into the receiving space 130. In an exemplary embodiment, the latches 124 may be deflected from the latched position to an unlatched position, in which the latches 124 are splayed outward. In the unlatched position, the optical device 110 may be removed from the receiving space 130. As such, the optical device 110 may be removed and replaced with a different optical device 110. Alternatively, the optical device 110 may be removed and repositioned within the receiving space 130, such as to redirect the lighting pattern from the optical device 110.

Having the optical device 110 removably coupled to the clip 120, allows the solid state lighting assembly 100 to be easily configurable. A modular design is thus provided in which different optical characteristics may be achieved in a cost-effective and reliable manner. The clip 120 is configured to receive many different types of optical devices 110, each having different optical characteristics. For example, the optical devices 110 may have similar outer perimeters and/or dimensions to be positioned within the receiving space 130 and be engaged by the clip 120. Each of the different optical devices 110 may provide different patterns for lighting. Additionally, the clip 120 may be configured to receive optical devices 110 that have different outer perimeters or dimensions. For example, the optical devices 110 may have different shapes. The latches 124 may be deflected or manipulated to engage the different optical devices 110.

FIG. 3 is a bottom perspective view of the clip 120. The clip 120 includes the base 122 and three latches 124. The latches 124 extend upward from the base 122. In an exemplary embodiment, the clip 120 may be manufactured from a metal material. For example, the clip 120 may be a stamped metal part. The latches 124 and base 120 may be formed integral with one another. The base 122 includes a ring 132 surrounding an open center 134. In the illustrated embodiment, the ring 132 is circular in shape. Other shapes are possible in alternative embodiments, such as an oval shape, a rectangular shape, a square shape, an irregular shape and the like.

The base 122 includes mounting legs 136 extending downward from the ring 132. The mounting surfaces 126 are provided at a bottom of the mounting legs 136. The mounting legs are L-shaped and have a vertical section 138 and a horizontal section 140. The vertical section 138 extends downward from the ring 132. The horizontal section 140 extends outward from the vertical section 138. Optionally, the horizontal section 140 may be substantially perpendicular with respect to the vertical section 138.

In an exemplary embodiment, three mounting legs 136 are provided. The mounting legs 136 are aligned with the latches 124. The mounting legs 136 extend in an opposite direction as the latches 124. Optionally, the vertical sections 138 of the mounting legs 136 may be relatively short as compared to the latches 124 which may be relatively long. As such, the ring 132 is configured to be positioned proximate to the substrate 102 (shown in FIG. 2). Alternatively, the vertical sections 138 and the latches 124 may have similar lengths such that the ring 132 is proximately centered between the mounting surfaces 126 and the latching surfaces 128. In other alternative embodiments, the vertical sections 138 may be relatively long and the latches 124 may be relatively short, such that the ring 132 is configured to be positioned proximate to the light emitting end 114 (shown in FIG. 2) of the optical device 110 (shown in FIG. 2). The latches 124 may be spaced equidistance apart from one another. Alternatively, the latches 124 may be positioned different radial distances from one another. The ring 132 is used to position the latches 124 with respect to one another. For example, the size and shape of the ring 132 dictates the relative positions of the latches 124 with respect to one another.

The latches 124 have hook ends 142 at the distal ends thereof. The latching surfaces 128 are provided on the hook ends 142. When the optical device 110 is loaded into the clip 120, the hook ends 142 engage the optical device 110 and apply downward pressure on the optical device 110 to hold the optical device 110 against the solid state lighting device 106 (shown in FIG. 2). The hook ends 142 include fingers 144 at the ends thereof. The fingers 144 may be at least partially deflected when the optical device 110 is loaded into the receiving space 130. The fingers 144 thus provide a biasing force to hold the optical device 110 within the receiving space 130.

FIG. 4 is a perspective of an alternative clip 160 for use within the solid state lighting assembly 100 (shown in FIG. 2). The clip 160 may be used to replace the clip 120 (shown in FIG. 2). In an exemplary embodiment, multiple clips 160 may be used to replace the clip 120. When the clips 160 are arranged around the optical device 110, the clips 160 cooperate to secure the optical device 110 in position with respect to the solid state lighting device 106 (shown in FIG. 2). The clips 160 operate in a similar manner as the clip 120, however the clips 160 are separate from one another.

The clip 160 includes a base 162 and a latch 164. The base 162 may have similar features as the base 122 (shown in FIG. 2), however the base 162 does not include the ring 132 (shown in FIG. 2). As such, when multiple clips 160 are used to secure the optical device 110 (shown in FIG. 2) the clips 160 remain separate from other clips 160. Each of the clips 160 are separately mounted to the substrate 102. The base 162 includes mounting surfaces 166 configured to be mounted to the substrate 102.

The latch 164 is similar to the latch 124 (shown in FIG. 2). The latch 164 extends from the base 162 and includes a latching surface 168. The latching surface 168 is configured to engage the clip engagement feature 116 (shown in FIG. 2) when the optical device 110 is positioned within the clip 160. The latch 164 is deflectable and may be moved between a latched position and an unlatched position.

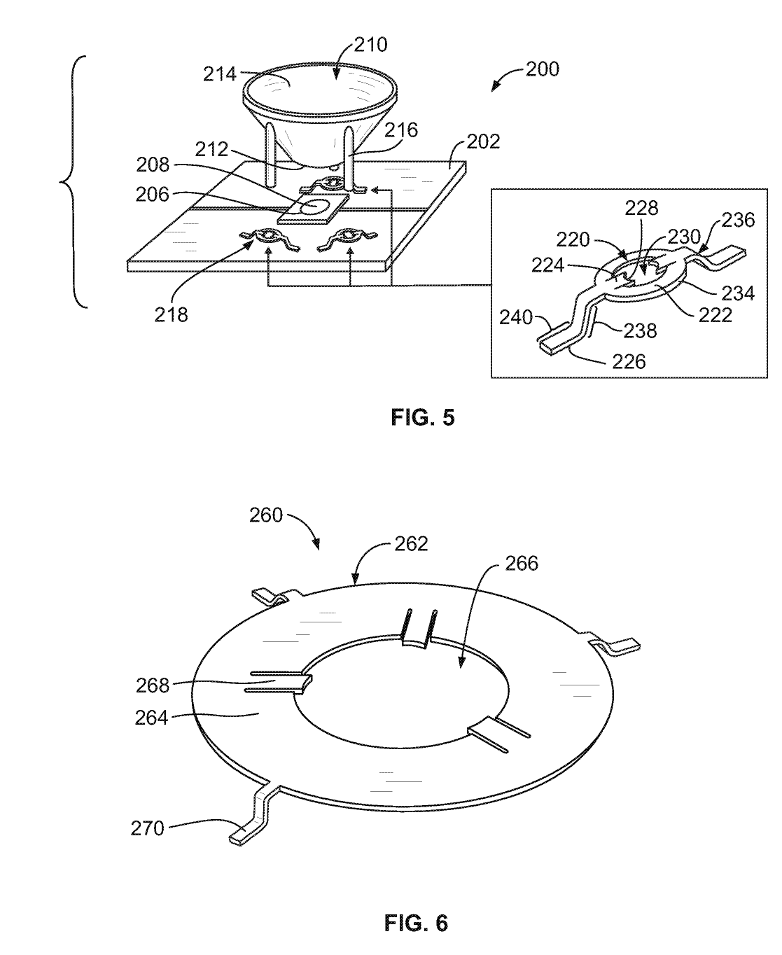

FIG. 5 is a perspective view of an alternative solid state lighting assembly 200. The solid state lighting assembly 200 is configured for use with the lighting fixture 10 (shown in FIG. 1) in place of the solid state lighting assembly 14. The solid state lighting assembly 200 may be used in other types of lighting fixtures other than a light bar.

The solid state lighting assembly 200 includes a substrate 202 and a solid state lighting device 206 mounted to the substrate 202. The substrate 202 and solid state lighting device 206 may be similar to the substrate 102 and solid state lighting device 106 (both shown in FIG. 1). The substrate 202 is configured to be mounted to the base 12 (shown in FIG. 1). The solid state lighting device 206 may constitute a light emitting diode (LED), or another type of solid state lighting devices. The solid state lighting device 206 emits light through an end 208 thereof.

The solid state lighting assembly 200 includes an optical device 210, which may be similar to the optical device 110 (shown in FIG. 2). The optical device 210 includes a light receiving end 212 and light emitting end 214 opposite the light receiving end 212. In an exemplary embodiment, the light receiving end 212 is positioned adjacent to the end 208 of the solid state lighting device 206. In an exemplary embodiment, the optical device 210 constitutes a lens.

The optical device 210 includes one or more clip engagement features 216. In the illustrated embodiment, the clip engagement features 216 constitute posts that extend downward form the outer surface of the optical device 210. The clip engagement features 216 have a predetermined shape, such as a circular shape. Any number of clip engagement features 216 may be provided depending on the particular embodiment. Optionally, the posts may include threads, notches, protrusions and the like on the outer surface thereof. Optionally, the clip engagement features 216 may extend downward such that distal ends of the clip engagement features 216 are approximately coplanar with the light receiving end 212.

The solid state lighting assembly 200 includes a retainer 218 configured to hold the optical device 210 in position with respect to the solid state lighting device 206. In an exemplary embodiment, the retainer 218 includes one or more clips 220 configured to removably couple the optical device 210 to the solid state lighting device 206. Any number of clips 220 may be used to secure the optical device 210. Optionally, three clips 220 may be utilized to help center the optical device 210 with respect to the solid state lighting device 206. Alternatively, less than three clips 220, such as two clips 220 or a single clip 220, may be provided. In other alternative embodiments, more than three clips 220 may be provided.

Each clip 220 includes a base 222 and at least one latch 224. The base 222 has one or more mounting surfaces 226 configured to be mounted to the substrate 202, such as by a soldering process. The clip 220 may be manufactured from a metal material. For example, the clip 220 may be a stamped metal part. The latches 224 and base 222 may be formed integral with one another.

The latches 224 extend from the base 222. The latches 224 include latching surfaces 228 that engage the optical device 210. The latches 224 engage the clip engagement features 216 of the optical device 210. For example, in the illustrated embodiment, the base 222 includes openings 230 therethrough proximate to the latches 224. The latches 224 are generally coplanar with the base and extend into the openings 230. Optionally, the latches 224 may be biased downward to receive the optical device 210 through the opening 230. When the optical device 210 is mounted to the clips 220, the clip engagement features 216 are received in the openings 230. The latches 224 engage the sides of the clip engagement features 216 to secure the optical device 210 with respect to the clips 220. When the clip engagement features 216 include threads, notches or protrusions, the latches 224 may engage the threads, notches or protrusions to further secure the latches 224 to the clip engagement features 216.

Optionally, the latches 224 are deflectable and are deflected downward when the clip engagement features 216 are loaded into the openings 230. The latches 224 are biased against the clip engagement features 216 to secure the clip engagement features 216 within the openings 230. In an exemplary embodiment, multiple latches 224, such as two latches 224 as in the illustrated embodiment, are provided on opposite sides of each opening 230. The latches 224 cooperate to secure the clip engagement features 216 therebetween. The latches 224 operate as spring fingers to bias against the clip engagement features 216. In an exemplary embodiment, the latches 224 operate similar to an axle nut, where the latches 224 bite into the clip engagement features 216 to secure the clip engagement features 216 within the openings 230.

Optionally, the openings 230 may be keyed to orient the optical device 210 in a particular orientation. For example, the openings 230 may be differently sized or shaped to accept particular clip engagement features 216, wherein only one orientation of the optical device 210 is possible. Alternatively, the clips 220 may be mounted to the substrate 202 in a particular orientation such that the optical device 210 can only be connected to the clips 220 in one particular orientation.

The base 222 includes a platform 234 and mounting legs 236 extending downward from the platform 234. The opening 230 extends through the platform 234. The latches 224 extend from the platform 234. The mounting surfaces 226 are provided at a bottom of the mounting legs 236. The mounting legs are L-shaped and have a vertical section 238 and a horizontal section 240. The vertical section 238 extends downward from the platform 234. The horizontal section 240 extends outward from the vertical section 238. Optionally, the horizontal section 240 may be substantially perpendicular with respect to the vertical section 238. In an exemplary embodiment, each clip 220 includes two mounting legs 236 that extend in opposite directions from one another.

Having the optical device 210 removably coupled to the clip 220, allows the solid state lighting assembly 200 to be easily configurable. A modular design is thus provided in which different optical characteristics may be achieved in a cost-effective and reliable manner. The clip 220 is configured to receive many different types of optical devices 210, each having different optical characteristics.

FIG. 6 is a perspective of an alternative clip 260 for use within the solid state lighting assembly 200 (shown in FIG. 5). The clip 260 may be used to replace the clips 220 (shown in FIG. 5). The clip 260 operates in a similar manner as the clips 220, however the clip 260 is a unitary structure that is mounted to the substrate 202 (shown in FIG. 5), as opposed to separate pieces individually mounted to the substrate 202.

The clip 260 includes a base 262 having a ring 264. The base 262 includes a central opening 266 surrounded by the ring 264. Latches 268 extend from the base 262 into the opening 266. The opening 266 receives an optical device therein. The latches 268 engage the optical device to hold the optical device in the opening 266. The base 262 includes mounting legs 270 extending from the ring 264.

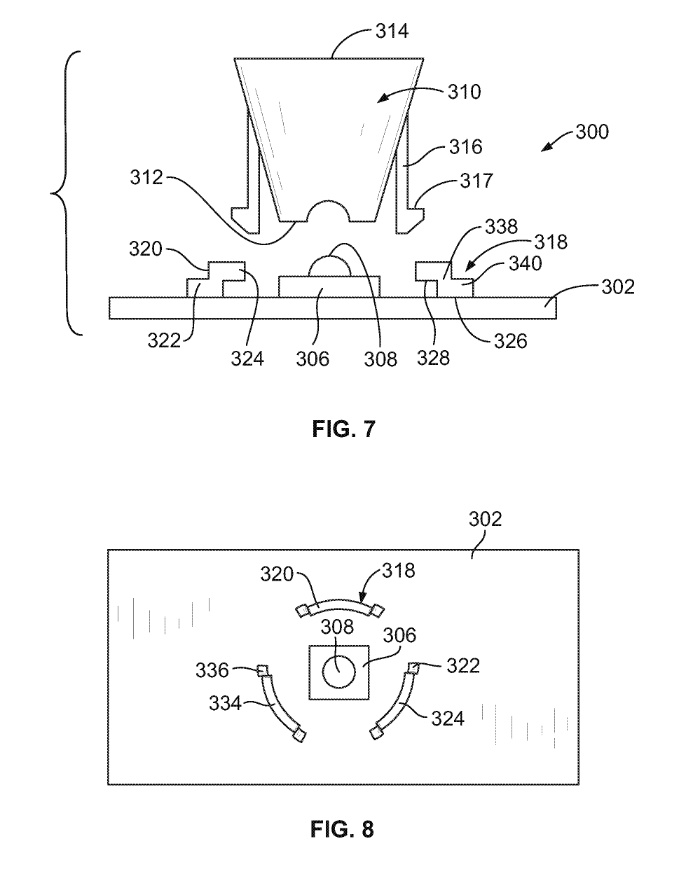

FIG. 7 is a side view of an alternative solid state lighting assembly 300. FIG. 8 is a top view of a portion of the solid state lighting assembly 300. The solid state lighting assembly 300 is configured for use with the lighting fixture 10 (shown in FIG. 1) in place of the solid state lighting assembly 14. The solid state lighting assembly 300 may be used in other types of lighting fixtures other than a light bar.

The solid state lighting assembly 300 includes a substrate 302 and a solid state lighting device 306 mounted to the substrate 302. The substrate 302 and solid state lighting device 306 may be similar to the substrate 102 and solid state lighting device 106 (both shown in FIG. 1). The substrate 302 is configured to be mounted to the base 12 (shown in FIG. 1). The solid state lighting device 306 may constitute a light emitting diode (LED), or another type of solid state lighting devices. The solid state lighting device 306 emits light through an end 308 thereof.

The solid state lighting assembly 300 includes an optical device 310 (shown in FIG. 7), which may be similar to the optical device 110 (shown in FIG. 2). The optical device 310 is not shown in FIG. 8. The optical device 310 includes a light receiving end 312 and light emitting end 314 opposite the light receiving end 312. In an exemplary embodiment, the light receiving end 312 is positioned adjacent to the end 308 of the solid state lighting device 306. In an exemplary embodiment, the optical device 310 constitutes a lens.

The optical device 310 includes one or more clip engagement features 316. In the illustrated embodiment, the clip engagement features 316 constitute posts that extend downward form the outer surface of the optical device 310. The clip engagement features 316 have catch surface 317 at distal ends thereof. The clip engagement features 316 may be deflectable and, operate as latches during assembly of the solid state lighting assembly 300 to secure the optical device 310 in position with respect to the solid state lighting device 306. Any number of clip engagement features 316 may be provided depending on the particular embodiment. Optionally, the clip engagement features 316 may extend downward such that distal ends of the clip engagement features 316 are approximately coplanar with the light receiving end 312.

The solid state lighting assembly 300 includes a retainer 318 configured to hold the optical device 310 in position with respect to the solid state lighting device 306. In an exemplary embodiment, the retainer 318 includes one or more clips 320 configured to removably couple the optical device 310 to the solid state lighting device 306. Any number of clips 320 may be used to secure the optical device 310. Optionally, three clips 320 may be utilized to help center the optical device 310 with respect to the solid state lighting device 306. Alternatively, less than three clips 320, such as two clips 320 or a single clip 320, may be provided. In other alternative embodiments, more than three clips 320 may be provided.

Each clip 320 includes a base 322 and a latch 324. The base 322 has one or more mounting surfaces 326 configured to be mounted to the substrate 302, such as by a soldering process. The clip 320 may be manufactured from a metal material. For example, the clip 320 may be a stamped metal part. The latch 324 and base 322 may be formed integral with one another.

Each latch 324 extends from the corresponding base 322. The latch 324 includes a latching surface 328 at a bottom thereof that engages the optical device 310. The latch 324 engages the clip engagement features 316 of the optical device 310. For example, the catch surfaces 317 of the clip engagement features 316 are captured below respective latching surfaces 328 to secure the optical device 310 with respect to the clips 320.

The base 322 includes a platform 334 and mounting legs 336 extending downward from the platform 334. The latching surfaces 328 are provided below the platforms 334. The mounting surfaces 326 are provided at a bottom of the mounting legs 336. The mounting legs are L-shaped and have a vertical section 338 and a horizontal section 340. The vertical section 338 extends downward from the platform 334. The horizontal section 340 extends outward from the vertical section 338. Optionally, the horizontal section 340 may be substantially perpendicular with respect to the vertical section 338. In an exemplary embodiment, each clip 320 includes two mounting legs 336 that extend in opposite directions from one another.

Having the optical device 310 removably coupled to the clip 320, allows the solid state lighting assembly 300 to be easily configurable. A modular design is thus provided in which different optical characteristics may be achieved in a cost-effective and reliable manner. The clip 320 is configured to receive many different types of optical devices 310, each having different optical characteristics.

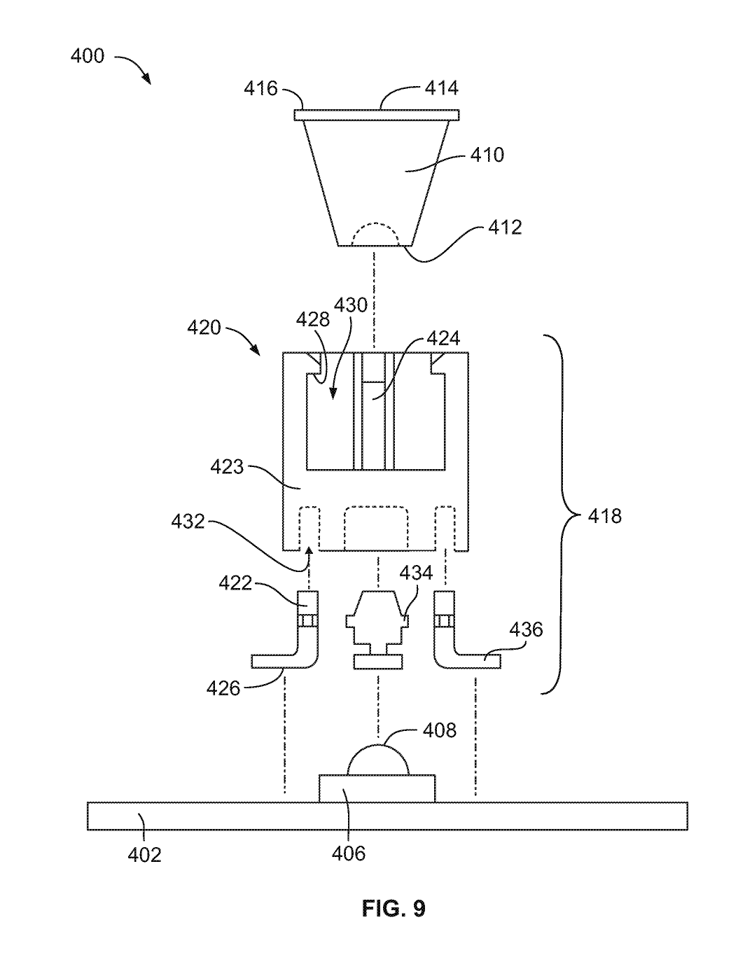

FIG. 9 is an exploded view an alternative solid state lighting assembly 400. The solid state lighting assembly 400 is configured for use with the lighting fixture 10 (shown in FIG. 1) in place of the solid state lighting assembly 14. The solid state lighting assembly 400 may be used in other types of lighting fixtures other than a light bar.

The solid state lighting assembly 400 includes a substrate 402 and a solid state lighting device 406 mounted to the substrate 402. The substrate 402 and solid state lighting device 406 may be similar to the substrate 102 and solid state lighting device 106 (both shown in FIG. 1). The substrate 402 is configured to be mounted to the base 12 (shown in FIG. 1). The solid state lighting device 406 may constitute a light emitting diode (LED), or another type of solid state lighting devices. The solid state lighting device 406 emits light through an end 408 thereof.

The solid state lighting assembly 400 includes an optical device 410, which may be similar to the optical device 110 (shown in FIG. 2). The optical device 410 includes a light receiving end 412 and light emitting end 414 opposite the light receiving end 412. In an exemplary embodiment, the light receiving end 412 is positioned adjacent to the end 408 of the solid state lighting device 406. In an exemplary embodiment, the optical device 410 constitutes a lens.

The optical device 410 includes one or more clip engagement features 416. Optionally, the clip engagement feature 416 may constitute a planar surface. Alternatively, the clip engagement feature 416 may constitute a pocket. Alternatively, the clip engagement feature 416 may constitute a protrusion. In another alternative embodiment, the clip engagement feature 416 may constitute a shoulder or ledge.

The solid state lighting assembly 400 includes a retainer 418 configured to hold the optical device 410 in position with respect to the solid state lighting device 406. In an exemplary embodiment, the retainer 418 includes a clip 420 configured to removably couple the optical device 410 to the solid state lighting device 406. Each clip 420 includes one or more bases 422 and a holder 423 separately provided from the bases 422. The holder includes a one or more latches 424.

Each base 422 has one or more mounting surfaces 426 configured to be mounted to the substrate 402, such as by a soldering process. The base 422 may be manufactured from a metal material. For example, the base 422 may be a stamped metal part. The bases 422 may be first coupled to the holder 423 and then mounted to the substrate 402. Alternatively, the bases 422 may be mounted to the substrate 402 and then the holder 423 coupled to the bases 422.

The holder 423 may be manufactured from a plastic material. For example, the holder 423 may be insert molded from a plastic material. The latches 424 are formed integral with the holder 423 and extend from the holder 423. Alternatively, the latches 424 may be separate and discrete from the holder 423, and coupled to the holder 423. In such embodiment, the latches may be manufactured from a different material, such as a metal material. The latches 424 include latching surfaces 428 that engage the optical device 410. The latches 424 engage the clip engagement features 416 of the optical device 410. The holder 423 defines a receiving space 430 for receiving the optical device 410. The latches 424 are positioned around the receiving space 430 to engage different portions of the optical device 410 to hold the optical device 410 within the receiving space 430. The holder 423 includes a plurality of pockets 432 that are open at a bottom of the holder 423. The pockets 432 receive the bases 422.

The base 422 includes a retention portion 434 and a mounting leg 436 extending downward from the retention portion 434. The retention portion 434 includes barbs or other features that secure the base 422 in the pocket 432, such as by an interference fit. The mounting surfaces 426 are provided at a bottom of the mounting legs 436. The mounting legs are L-shaped, but may have other shapes in alternative embodiments.

Having the optical device 410 removably coupled to the clip 420, allows the solid state lighting assembly 400 to be easily configurable. A modular design is thus provided in which different optical characteristics may be achieved in a cost-effective and reliable manner. The clip 420 is configured to receive many different types of optical devices 410, each having different optical characteristics.

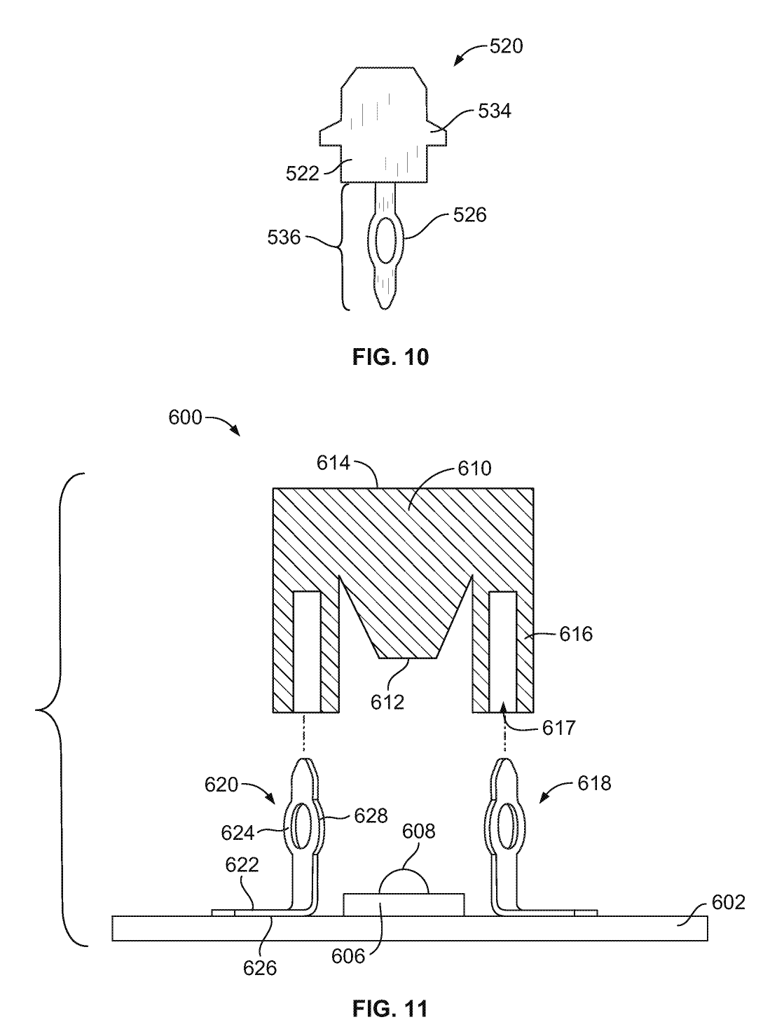

FIG. 10 is a side view of a portion of an alternative clip 520 for the solid state lighting system 400 (shown in FIG. 9). The clip 520 also includes a holder similar to the holder 423 (shown in FIG. 9). The clip 520 includes a base 522 having one or more mounting surfaces 526 configured to be mounted to the substrate 402 (shown in FIG. 9), such as by press-fit attachment into a via or hole on the substrate 402. The base 522 may be manufactured from a metal material. For example, the base 522 may be a stamped metal part.

The base 522 includes a retention portion 534 and a mounting leg 536 extending downward from the retention portion 534. The retention portion 534 includes barbs or other features that secure the base 522 in the pocket 432 (shown in FIG. 9), such as by an interference fit. The mounting surfaces 526 are provided along the mounting leg 536. The mounting leg 536 constitutes a press-fit pin, such as an eye-of-the-needle pin. In an exemplary embodiment, the mounting leg 536 is received in the substrate 402 such that the mounting leg 536 does not extend beyond the substrate 402. As such, the substrate 402 as able to be mounted to the base 12, (shown in FIG. 1), such as for heat dissipation.

FIG. 11 is a side view of another alternative solid state lighting system 600. The solid state lighting assembly 600 is configured for use with the lighting fixture 10 (shown in FIG. 1) in place of the solid state lighting assembly 14. The solid state lighting assembly 600 may be used in other types of lighting fixtures other than a light bar.

The solid state lighting assembly 600 includes a substrate 602 and a solid state lighting device 606 mounted to the substrate 602. The substrate 602 and solid state lighting device 606 may be similar to the substrate 102 and solid state lighting device 106 (both shown in FIG. 1). The substrate 602 is configured to be mounted to the base 12 (shown in FIG. 1). The solid state lighting device 606 may constitute a light emitting diode (LED), or another type of solid state lighting devices. The solid state lighting device 606 emits light through an end 608 thereof.

The solid state lighting assembly 600 includes an optical device 610, which may be similar to the optical device 110 (shown in FIG. 2). The optical device 610 includes a light receiving end 612 and light emitting end 614 opposite the light receiving end 612. In an exemplary embodiment, the light receiving end 612 is positioned adjacent to the end 608 of the solid state lighting device 606. In an exemplary embodiment, the optical device 610 constitutes a lens.

The optical device 610 includes one or more clip engagement features 616. In the illustrated embodiment, the clip engagement features 616 constitute posts that extend downward form the outer surface of the optical device 610. The clip engagement features 616 have pockets 617 at distal ends thereof. The pockets 617 are open at the distal ends. Any number of clip engagement features 616 may be provided depending on the particular embodiment. Optionally, the clip engagement features 616 may extend downward such that distal ends of the clip engagement features 616 are positioned lower than the light receiving end 612.

The solid state lighting assembly 600 includes a retainer 618 configured to hold the optical device 610 in position with respect to the solid state lighting device 606. In an exemplary embodiment, the retainer 618 includes one or more clips 620 configured to removably couple the optical device 610 to the solid state lighting device 606. Any number of clips 620 may be used to secure the optical device 610. Optionally, three clips 620 may be utilized to help center the optical device 610 with respect to the solid state lighting device 606. Alternatively, less than three clips 620, such as two clips 620 or a single clip 620, may be provided. In other alternative embodiments, more than three clips 620 may be provided. Alternatively, rather than individual clips 620, a single clip may be provided with a ring connecting the components of the clip together.

Each clip 620 includes a base 622 and a latch 624. The base 622 has one or more mounting surfaces 626 configured to be mounted to the substrate 602, such as by a soldering process. The clip 620 may be manufactured from a metal material. For example, the clip 620 may be a stamped metal part. The latches 624 and base 622 may be formed integral with one another.

The latches 624 extend from the base 622. The latches 624 include latching surfaces 628 that engage the optical device 610. The latches 624 engage the clip engagement features 616 of the optical device 610. For example, the latches 624 may be received in the pockets 617 of the clip engagement features 616 to secure the optical device 610 with respect to the clips 620. The latching surfaces 628 include barbs or other features that secure the bases 622 in the pockets 617, such as by an interference fit. The latches 624 may constitute press-fit pins, such as an eye-of-the-needle pins.

Having the optical device 610 removably coupled to the clip 620, allows the solid state lighting assembly 600 to be easily configurable. A modular design is thus provided in which different optical characteristics may be achieved in a cost-effective and reliable manner. The clip 620 is configured to receive many different types of optical devices 610, each having different optical characteristics.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A solid state lighting assembly comprising:
a solid state lighting device emitting light;
an optical device positioned adjacent the solid state lighting device and receiving the light emitted from the solid state lighting device; and
a clip holding the optical device relative to the solid state lighting device, the clip comprising a base configured to be mounted to a substrate proximate to the solid state lighting device, and a latch extending from the base, the latch having a latching surface engaging the optical device to hold the optical device in position with respect to the solid state lighting device.

2. The system of claim 1, wherein the mounting surface is configured to be soldered to the substrate.

3. The system of claim 1, wherein the latch is movable between a latched position and an unlatched position, the latch being configured to engage the optical device in the latched position, the optical device being removable from the clip in the unlatched position.

4. The system of claim 1, wherein the optical device includes a post extending therefrom, the latch engaging the post to secure the optical device with respect to the clip.

5. The system of claim 1, wherein the optical device includes a deflectable post having a catch surface, the catch surface being captured below the latching surfacing to hold the optical device in position with respect to the solid state lighting device.

6. The system of claim 1, wherein the optical device includes a light receiving end and a light emitting end, the light receiving end being positioned adjacent the solid state lighting device, the latch engaging the light emitting end to hold the light receiving end in position with respect to the solid state lighting device.

7. A clip for holding an optical device with respect to a solid state lighting device, the clip comprising:
a base having a mounting surface configured to be mounted to a substrate proximate to the solid state lighting device; and
a latch extending from the base, the latch having a latching surface being configured to engage the optical device to hold a relative position of the optical device with respect to the base.

8. The clip of claim 7, wherein the mounting surface is configured to be soldered to the substrate.

9. The clip of claim 7, wherein the base includes a ring having an open center, the base being configured to be mounted to the substrate such that the solid state lighting device and the optical device are aligned with the open center of the ring, the clip having a plurality of latches extending from the base spaced apart along the ring, the plurality of latches cooperating to hold the optical device.

10. The clip of claim 7, wherein the latch is movable between a latched position and an unlatched position, the latch being configured to engage the optical device in the latched position, the optical device being removable from the clip in the unlatched position.

11. The clip of claim 7, wherein the latch includes a hook end opposite the base, the latching surface being provided at the hook end.

12. The clip of claim 7, wherein the latch constitutes a first latch, the clip further comprising a second latch, the first and second latches facing one another and being configured to receive the optical device therebetween.

13. The clip of claim 7, wherein the latch constitutes a first latch, the clip further comprising a second latch, the first and second latches being generally coplanar with the base and receiving a portion of the optical device therebetween, the first and second latches biting into the portion of the optical device to secure the optical device with respect to the base.

14. The clip of claim 7, further comprising a holder separately provided from the base, the holder comprises the latch, the holder being coupled to the base by an interference fit.

15. The clip of claim 7, wherein the base includes a press-fit pin, the press-fit pin comprising the mounting surface.

16. The clip of claim 7, wherein the latch includes a press-fit pin, the press-fit pin being configured to be received in an opening in the optical device.

17. The clip of claim 7, wherein the base is a stamped and formed metal part configured to be soldered to the substrate.

18. A retainer for optical devices, the retainer comprising
a clip having a base surface mounted to a substrate proximate to a solid state lighting device, the clip having a receiving space removably receiving the optical devices therein, the clip having a latch configured to engage the optical devices to hold the optical devices in the receiving space, wherein the clip is configured to selectively receive in the receiving space different types of optical devices having different optical characteristics without removing the clip or the solid state lighting assembly.

19. The retainer of claim 18, wherein the base is configured to be soldered to the substrate.

20. The retainer of claim 18, wherein the latch is movable between a latched position and an unlatched position, the latch being configured to engage the selected optical device in the latched position, the selected optical device being removable from the clip in the unlatched position.
